(19) United States
(12) Patent Application Publication
(10) Pub. No.: US 2025/0276779 A1
(43) Pub. Date: Sep. 4, 2025

(54) System and Associated Methods for an Aerial Device to Provide Airborne Payloads

(71) Applicant: Osprey Aeromarine, LLC, Palm Bay, FL (US)

(72) Inventor: Bruce Hartt, Palm Bay, FL (US)

(73) Assignee: Osprey Aeromarine, LLC, Palm Bay, FL (US)

(21) Appl. No.: 19/068,708

(22) Filed: Mar. 3, 2025

Related U.S. Application Data
(60) Provisional application No. 63/560,213, filed on Mar. 1, 2024.

(51) Int. Cl. B64C 1/22; B64C 3/38; B64D 17/80; B64D 31/00

(52) U.S. Cl. CPC B64C 1/22; B64C 3/38; B64D 17/80; B64D 31/00

(57) ABSTRACT

An aerial device is provided that comprises a body member and a retention member that may include an interior space and a rearward portion that may be operable to matingly engage with a forward portion of the body member to carry a payload within the interior space, which may be in cooperation with the forward portion of the body member. The retention member may include a collar that may have an inner perimeter that may define an opening in communication with the interior space. A forward portion of the payload may extend through the opening while the rearward portion of the retention member is matingly engaged with the forward portion of the body member. The inner perimeter of the collar may substantially abut a portion of an outer surface of the payload while the retention member is matingly engaged with the body member.

### FIELD OF THE INVENTION

The present invention relates to systems and methods for carrying payloads and aerial transportation and delivery thereof.

### BACKGROUND OF THE INVENTION

The prior art often faces significant limitations when it comes to effective transportation of various payloads. Current solutions predominantly focus on integrating payloads with the transportation and delivery devices of the prior art. Such delivery devices and payloads of the prior art are designed and specifically intended from conception to final assembly to be self-propelled and integrated with one another. As such, the prior art provides overly complex, expensive, inefficient payload delivery systems that are often and quickly in scarce supply due to their long and complex production processes, and inconveniently intricate designs. As such, there is a need for more versatile, cost effective, simple, efficient, and/or effective solutions for non-manual aerial transportation and aerial delivery of payloads that can provide similar and comparable results with low complexity, greater economic efficiency, and greater scalability to supply demands therefor. There is also a need for payload delivery systems which can selectively carry different payload types for aerial transportation and delivery, including such payload types in large supply, and specifically including such payloads that were not intended for self-propelled aerial transportation, which generally may be efficiently mass produced compared to the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to an aerial device that comprises a body member and a retention member. The retention member may include an interior space and a rearward portion that may be operable to matingly engage with a forward portion of the body member to carry a payload within the interior space, which may be in cooperation with the forward portion of the body member. The retention member may include a collar that may have an inner perimeter that may define an opening that may be in communication with the interior space. A forward portion of the payload may extend through the opening while the rearward portion of the retention member is matingly engaged with the forward portion of the body member. The inner perimeter of the collar may substantially abut a portion of an outer surface of the payload while the rearward portion of the retention member is matingly engaged with the forward portion of the body member.

In some embodiments of the present invention, the retention member may include one or more of a rail that may have an end portion thereof connected to the collar. At least a portion of an inward surface of the one or more rail(s) may significantly abut a portion of the outer surface of the payload while the rearward portion of the retention member is matingly engaged with the forward portion of the body member. Some embodiments of the present invention may include one or more of an engagement member that may be mounted on the body member and/or the retention member. The one or more engagement member may be operable to be reversibly engaged with an engagement unit of an aerial vehicle.

Some embodiments of the present invention may include a thruster that may be to selectively provide a thrust force, and one or more fins that may be connected to and extending from the body member. At least a portion of each one of the fins may be operable to rotatably move. Some embodiments of the present invention may further include wings that may be connected to the body member and/or the retention member. At least a portion of each of the wings may be operable to rotatably move.

Some embodiments of the present invention may include a travel propulsion member that may be mounted on and extending from a portion of the body member and/or a portion of the retention member. The travel propulsion member may be operable to generate a travel thrust in a rearward direction.

Some embodiments of the present invention may further include one or more of a controller, a sensor, and a power unit. The controller may be in communication with the thruster and the fins. The sensor(s) may be positionable in communication with the controller and may be operable to sense one or more of a characteristic data point. The power unit may be in communication with the controller and/or the at least one sensor. The sensor(s) may be is operable to provide a sensor signal based on the characteristics data point. The controller may be operable to selectively control the thruster and/or the fins based on the sensor signal.

Some embodiments of the present invention may include one or more of a body communication point and a retention communication point. The body communication point(s) may be carried by the body member, and the retention communication point(s) may be carried by the retention member. The controller and/or the power unit may be carried by the body member and may be in communication with one or more of the body communication point(s). One or more of the sensor(s) may be carried by the retention member and may be in communication with one or more of the retention communication point(s).

One or more of the body communication point(s) may be engaged in communication with one or more of the retention communication point(s) when and/or while the rearward portion of the retention member is matingly engaged with the forward portion of the body member. In some embodiments of the present invention, the controller may be operable to determine one or more of a path of travel based on the sensor signal. The controller may be further operable to selectively control one or more of the thruster and/or the fins based on one or more of the path(s) of travel determined.

Some embodiments of the present invention may be directed to an aerial device comprising a body member, a retention member, one or more engagement members, a thruster, and one or more fins. The retention member may include an interior space and a rearward portion that may be operable to matingly engage with a forward portion of the body member to carry a payload within the interior space, which may be in cooperation with the forward portion of the body member. The one or more engagement member(s) may be mounted on the body member and/or the retention member. The thruster may be operable to selectively provide a thrust force. The fins may be connected to and/or extending from the body member.

The retention member may include a collar that may have an inner perimeter that may define an opening that may be in communication with the interior space. A forward portion of the payload may extend through the opening when and/or while the rearward portion of the retention member is matingly engaged with the forward portion of the body member. The inner perimeter of the collar may substantially abut a portion of an outer surface of the payload when and/or while the rearward portion of the retention member is matingly engaged with the forward portion of the body member.

The retention member may include one or more rails that may have an end portion thereof connected to the collar. At least a portion of an inward surface of the one or more rails may significantly abut a portion of the outer surface of the payload when and/or while the rearward portion of the retention member is matingly engaged with the forward portion of the body member. The one or more engagement member(s) may be operable to be reversibly engaged with an engagement unit of an aerial vehicle.

Some embodiments of the present invention may be directed to an aerial device that comprises a body member, a retention member, one or more engagement member(s), a thruster, fins, a controller, one or more sensors, a power unit, body communication point(s), and retention communication point(s). The retention member may include a collar and one or more rails. The rail(s) may include a forward end portion connected to the collar. The engagement member(s) may be mounted on the body member and/or one or more of the rail(s). The thruster may be operable to selectively provide a thrust force. The fins may be connected to and/or extending from the body member.

The controller in communication with the thruster and/or the fins. The sensor(s) may be operable to sense at least one characteristic data point. The power unit may be in communication with the controller, and the power unit may be positionable in communication with one or more of the sensor(s). The body communication point(s) may be carried by the body member. The retention communication point(s) may be carried by one or more of the rail(s).

The collar and the rail(s) may define an interior space. The collar may have an inner perimeter that may define an opening that may be in communication with the interior space. The rail(s) may include a rearward end portion that may be operable to matingly engage with a forward portion of the body member to carry a payload within the interior space, which may be in cooperation with the forward portion of the body member. A forward portion of the payload may extend through the opening when and/or while the rearward portion the one or more rail(s) is matingly engaged with the forward portion of the body member.

The inner perimeter of the collar and a portion of an inward surface of the rail(s) may substantially about a portion of an outer surface of the payload when and/or while the rearward portion of the rail(s) is matingly engaged with the forward portion of the body member. The engagement member(s) may be operable to be reversibly engaged with an engagement unit of an aerial vehicle. The sensor(s) may be operable to provide a sensor signal based on the at least one characteristics data point. A portion or more of each one of the fins may be operable to rotatably move.

The controller may be operable to selectively control one or more of the thruster and the fins based on the sensor signal. The controller and the power unit may be carried by the body member and may be in communication with one or more of the body communication point(s). One or more of the sensor(s) may be carried by the retention member and may be in communication with one or more of the retention communication point(s). One or more of the body communication point(s) may engage in communication with one or more of the retention communication point(s) when and/or while the rearward portion of the rail(s) is matingly engaged with the forward portion of the body member.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic illustration of an aerial device according to an embodiment of the present invention.

FIG. 2 is another schematic illustration of the aerial device according to FIG. 1, showing an air brake in the deployed position.

FIG. 3 is a schematic illustration of the aerial device according to FIG. 1, shown with wings.

FIG. 4 is a schematic illustration of the aerial device according to FIG. 3, shown with wings and a travel propulsion member.

FIG. 5 is a schematic illustration and partially exploded view of the aerial device according to FIG. 1.

FIG. 6 is a schematic illustration of the aerial device according to FIG. 1, with the aerial device illustratively shown being deployed from an aerial vehicle.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides an aerial device 100 to house and deliver a variety of payloads 102. Those skilled in the art may notice and appreciate that the various embodiments of the aerial device 100 as described herein may advantageously provide for the housing and delivery of payloads 102 comprising a variety of different shapes, sizes, and compositions, and specifically, for the housing and delivery of payloads 102 that normally were not, and/or could not be, housed and delivered by previous other aerial devices. More specifically, the aerial device 100 may be self-propelled and deployable from aircraft or other means of deployment, such as an aerial vehicle 602. The aerial device 100 may be modular and/or shaped and sized to house and deliver a variety of payloads 102 which comprise a variety of shapes, sizes, and compositions and that generally were not housed and/or delivered by self-propelled aerial devices for one reason. With the reasons including to lack of planning, unintended use, unintended purpose, failure to achieve such use or implementation, and/or unforeseen use and/or unforeseen implementation.

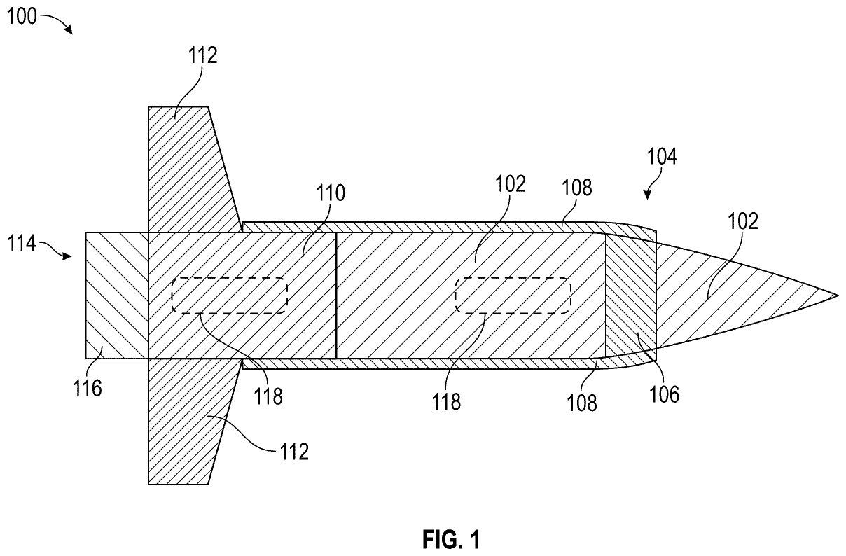

Initially referring to FIG. 1, the aerial device 100 may comprise a body member 110, a retention member 104, a thruster 116, and one or more fins 112. The aerial device 100 may be sized and configured to house, carry, and/or retain a payload 102. The retention member 104 may act in cooperation with the body member 110 to house, carry, and/or retain a payload 102. At least a portion of the retention member 104 may be configured, adapted, and/or operable to be removably, and/or non-removably, engaged and/or matingly engaged, with the body member 110 and/or with a forward portion of the body member 110, which may be to house, carry, secure, and/or retain the payload 102, and/or to house, carry, secure, and/or retain the payload 102 in cooperation with the body member 110 and/or the forward portion of the body member 110. All of, or at least a portion of the payload 102 may be positioned within an interior area/space of the aerial device 100 and/or an interior area/space the retention member 104 when and/or while the payload 102 is being housed, carried, and/or retained by the aerial device 100 and/or the retention member 104.

The thruster 116 may selectively provide a thrust force to cause the aerial device 100 and the payload 102 to be moved in a direction opposite from, and/or inverse of, the thrust force provided by the thruster 116. The thruster 116 may be positioned at an end of the aerial device 100 and/or the body member 110 that is opposite the retention member 104 and/or the payload 102 carried by the retention member 104 and/or by the aerial device 100. The thrust force provided by the thruster 116 may cause an exhaust 114 and/or propellant 120 to be released from the thruster 116 in the direction of the thrust force, which may be in a direction opposite and/or inverse to the direction of movement of the aerial device 100 and the payload 102 caused by the thrust force generated by the thruster 116.

The fins 122 may be positioned extending outwardly from one or more portions of the aerial device 100, the body member 110, and/or the retention member 104. The fins 112 may be utilized to provide for aerial steering, guidance, and/or control over a flight trajectory of the aerial device 100. The fins 112 may be controllable to move and change the position and angle of the fin 112 relative to the body member 110 and/or relative to the aerial device 100 to steer, guide, and control the flight trajectory of the aerial device 100.

Embodiments of the present invention may also include one or more engagement members 118 which may be mounted on a portion of an outer surface of the body member 110, the retention member 104, and/or the rail(s) 108. The engagement members 118 may be operable to be removably engaged and/or removably matingly engaged with other objects and components, such as, but without limitation, with a respective engagement unit 604 of an aerial vehicle 602. More details on the engagement members 118 follows further below.

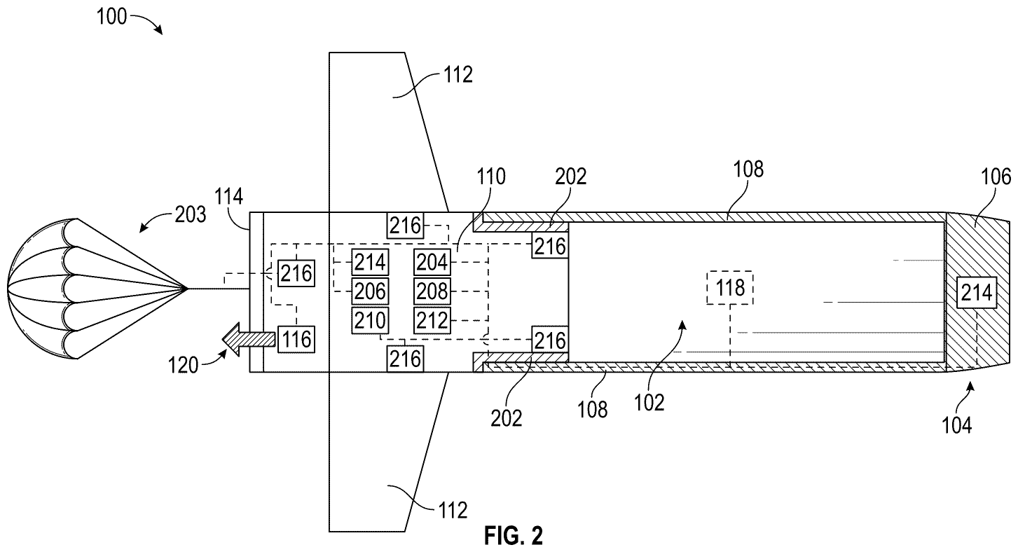

Now additionally referring to FIG. 2, embodiments of the present invention may include an air brake 203. The air brake 203 may be carried by the body member 110, and the air brake 203 may be utilized to slow the velocity of the aerial device 100 when the aerial device 100 is in flight. The air brake 203 may be deployable, and controllable to be deployed, from the aerial device 100. The air brake 203 may comprise one or more of a drogue chute, drag chute, and/or a parachute. However, it is contemplated that the air brake 203 may comprise other types of air brakes such as hinged spoiler brake or speed brake panel hingedly mounted on the body member 110 or the fins 112. The air brake 203 may be deployable from a stored position to a deployed position. The stored position of the air brake 203 may be defined as when the air brake 203 at least mostly contained within the body member 110 and/or when the air brake 203 is not extended outwardly from the body member 110. The deployed position of the air brake 203 may be defined as when the air brake 203 is at least partially extended outwardly from the body member 110, such that the air brake 203 may cause an air drag force against the body member 110 and/or against the aerial device 100 to attempt to slow the air velocity of the body member 110 and/or of the aerial device 100.

In some embodiments of the present invention, the retention member 104 may comprise one or more of a collar 106 and a rail 108. The collar 106 may comprise a ring shape and/or a conical shape having an opening that may be defined by an inner perimeter of the collar 106. The opening may be positioned at one or both ends of the collar 106. The opening may be extending from and/or between the interior area/space of the aerial device 100/of the retention member 104 and through and outwardly from the collar 106. The opening may be in communication and/or in fluidic communication with the interior space of the retention member 104 and/or with an environment adjacent to, external to, and/or exterior to, the collar 106 and/or the aerial device 100. The collar 106 may be shaped to have an inner perimeter surface of the collar 106 to be significantly abutting against an outside surface of a payload 102 that is, or to be, carried by the aerial device 100. The collar 106 may be connected with an end portion of the rail(s) 108. The collar 106 may also be connectable, removably connectable, matingly engaged, and/or removably matingly engaged with an end portion of the rail(s) 108.

The rails 108 may be comprise elongated extensions. The rails 108 may also comprise a single rail 108 that may have cylindrical shape and may have an opening at one or both ends of the cylindrical rail 108. It is contemplated that embodiments of the present invention may include any number of rails 108 and of rails 108 that comprise a variety of geometric shapes as may be understood by those who may have skill in the art. Thus, for the purposes of the present description of the present invention, the use of the term “rail 108” and “rails 108” should be understood to be used interchangeably as embodiments of the present invention may include a rail 108, may also include a plurality of rails 108.

The rails 108 may be formed and/or shaped such that at least a portion of an inward facing surface/at least a portion of a lower surface of the rails 108 may significantly abut against at least a portion of an outer surface of a payload 102 when and/or while the payload 102 is carried by the aerial device 100 and/or while the rearward portion of the retention member 104 and/or rails 108 is engaged with the forward portion of the body member 110. The rails 108 may be connected to, removably connectable with, engaged, and/or removably engaged with at one end with a portion of the collar 106. However, is contemplated that in some embodiments of the present invention, the rail(s) 108 and the collar 106 may be connected to each other as a single monolithic piece as the retention member 104. The rails 108 may also be connected to, removably connectable with, engaged, and/or removably engaged with a portion of the body member 110 and/or with a respective body connector 202 of the body member 110. Also, in some embodiments of the present invention, the rails 108 may be connected to, removably connectable with, engaged, and/or removably engaged with a forward portion of the body member 110 that is at an opposing side of the body member 110 as compared to a rearward portion of the body member 110 that at which the thruster 116 may be carried by the body member 110.

The body member 110 may comprise one or more body connectors 202. Embodiments of the present invention may include the same number of body connectors 202 as there are rails 108 and/or retention members 104. Each body connector 202 may be configured to be connected to, removably connectable with, engaged, and/or removably engaged with a respective rail 108. In embodiments of the present invention that include a single rail 108 having a cylindrical shape and/or a monolithic retention member 104 having a cylindrical shape, the body connector 202 may encompass at least a portion of a forward perimeter of the body member 110. The body connector(s) 202 may be controllable to be reversibly engaged with, and/or reversibly connected to, the one or more rails 108 and/or the retention member 104.

Now referring to FIGS. 1-6, some embodiments of the present invention may include a number of electronically powered and/or electronically controlled components. For example, but without limitation, the aerial device 100 may include one or more of a controller 204, a communication unit 206, a power unit 208, a data store 210, a data bus 212, sensors 214, and action members 216. To increase the level of terseness, for the purposes of the description of the present invention, and without limitation, the terms “electronically powered elements/components/members/units,” “electronically controlled elements/components/members/units,” “electronically powered elements/components/ members/units of the aerial device 100, and “electronically controlled elements/components/members/units of the aerial device 100” may be used interchangeably, and without limitation, to refer to one or more of the controller 204, the communication unit 206, the power unit 208, the data store 210, the data bus 212, the sensors 214, the action members 216, the thrusters 116, the fins 112, the payload 102, the engagement members 118, the air brake 203, wing(s) 302, the travel member 402, and the communication point 502 collectively, individually, and/or in any combination(s) thereof. More details on the wing(s) 302, the travel member 402, and the communication point 502 follows further below.

To further increase the level of terseness throughout the present application, since many components, devices, units, and members described herein may be in communication with one another, for the purposes of the present invention the terms “computer-readable communication elements/components/members/units” and “computer-readable communication elements/components/members/units of the aerial device 100” may be used interchangeably, and without limitation, to refer to one or more of the controller 204, the communication unit 206, the power unit 208, the data store 210, the data bus 212, the sensors 214, the action members 216, the thrusters 116, the fins 112, the payload 102, the engagement members 118, the air brake 203, the wings 302, the travel member 402, the communication point 502, a communication device 606, the aerial vehicle 602, and the engagement unit(s) 604 collectively, individually, and/or in any combination(s) thereof. More details on the communication device 606, the aerial vehicle 602, and the engagement unit(s) 604 follows further below.

The controller 204 may be carried by the body member 110. The controller 204 may be in communication with one or more of the electronically controlled components of the aerial device 100 and/or with one or more of the computer-readable communication elements. The controller 204 may be utilized to monitor, manage, selectively control and/or selectively operate one or more of the electronically controlled components of the aerial device 100 and/or with one or more of the computer-readable communication elements. The controller 204 may be configured to read, write, send, receive, compute, calculate, execute, process, and/or manage computer-readable data, information, code, instructions, and/or signals. Examples of the controller 204 include, but without limitation, a processor, microprocessor, microcontroller, central processing unit, graphics processing unit, field-programmable gate array, non-field-programmable gate array, and any combination thereof and any other machine processing unit that may be used as the controller 204 as may be understood by those who may have skill in the art. More details on the controller 204 follows throughout below.

The communication unit 206 may be carried by the body member 110. The communication unit 206 may be in communication with one or more of the electronically controlled components of the aerial device 100 and/or with one or more of the computer-readable communication elements. The communication unit 206 may be utilized to control, regulate, manage, relay, process, facilitate, and/or operate any computer-readable data, information, code, instructions, and/or signals to, from, and/or between one or more of the electronically controlled components of the aerial device 100 and/or with one or more of the computer-readable communication elements. Examples of the communication unit 206 may include, but without limitation, a network card, a transceiver, a receiver, a relay, a network switch, a router, a network modem, a hub, a radio, and antenna, and any combination thereof and any other device that may be used as the communication unit 206 for computer-readable communications as may be understood by those who may have skill in the art. More details on the communication device 606 and the aerial vehicle 602 follows further below.

The power unit 208 may be carried by the body member 110. The power unit 206 may be in communication with one or more of the electronically controlled components of the aerial device 100. The power unit 208 may be utilized to provide power, regulate power, monitor power, and/or control power, to and/or from one or more of the electronically controlled components of the aerial device 100. The power unit 208 may comprise one or more of, but without limitation, a fuel cell, a battery, a rechargeable battery, a generator, a capacitor, a solar cell, a power store, and any combination thereof and any other power providing device to use as the power unit 208 to provide power, such as electrical power, as may be understood by those who may have skill in the art.

In some embodiments of the present invention, the power unit 208 may include a fuel storage. The fuel storage of the power unit 208 may be in fluid communication with the thrusters 116, and the fuel storage of the power unit 208 may be utilized to provide fuel to the thrusters 116. The thrusters 116 may receive the fuel from the fuel storage of the power unit 208 and the thrusters 116 may utilize and combust the fuel to generate the thrust/thruster force. In other embodiments of the present invention, the thrusters 116 may include its own fuel storage to be utilized and combusted by the thrusters 116 to generate the thrust/thruster force.

The data store 210 may be carried by the body member 110. The data store 210 may be in communication with one or more of the electronically controlled components of the aerial device 100, and/or the data store 210 may also be in communication with one or more of the computer-readable communication elements. The data store 210 may include a computer-readable memory unit. The data store 210 may be utilized to read, write, store, send, receive, index, compute, and/or manage computer-readable data, information, code, instructions, and/or signals to and/or from one or more of the computer-readable communication elements. Examples of the data store 210 includes, but without limitation, a hard drive, a disk drive, magnetic tape, a solid-state drive, a floppy disk, a hard disk, computer-readable datastore, computer-readable memory, random access memory, non-random access memory, volatile computer-readable memory, non-volatile computer-readable memory, and any combination thereof and any other data storage device that may be used as the data store 210 as described herein as may be understood by those who may have skill in the art.

The data bus 212 may be carried by the body member 110. The data bus 212 may be in communication with one or more of the electronically controlled components of the aerial device 100. The data bus 212 may be utilized to control, regulate, manage, relay, process, facilitate, and/or operate any computer-readable data, information, code, instructions, and/or signals to, from, and/or between one or more of the electronically controlled components of the aerial device 100. Examples of the data bus 212 includes, but without limitation, a motherboard, a printed circuit board, a break-out board, a wiring harness, a communication relay, and any other components that may be utilized as the data bus 212 to facilitate computer-readable communication as may be understood by those who may have skill in the art.

Now referring to FIGS. 2-6, some embodiments of the aerial device 100 may include one or more action members 216. The action member 216 may be carried by the body member 110, and the action members 216 may be utilized to selectively cause one or more of the electronically controlled members of the aerial device 100 to move, actuate, and/or rotate relative to the action member 216 and/or relative to the body member 110. The action members 216 may also be utilized to cause one or more of the retention member 104 and/or the rail(s) 108 to be engaged with, connected to, removably engaged with, and/or removably connected to the body member 110, the forward portion(s) of the body member 110, the forward portion(s) of the body member 110, and/or the body connector(s) 202. The action member(s) 216 may also be utilized to cause the fin(s) 112 to move and/or change the position and angle of the fin(s) 112 relative to the body member 110 and/or relative to the aerial device 100, to steer, guide, and/or control the flight trajectory of the aerial device 100. The action member(s) 216 may also be utilized to actuate, deploy, release, and/or activate the air brake(s) 203 to cause the air brake(s) 203 to slow the velocity of the aerial device 100 when the aerial device 100 is in flight. The action member(s) 216 may also be utilized to grasp, retain, and/or be removably engaged with the payload 102 when the payload 102 is being carried by the body member 110, the retention member 104, the collar 106, and/or the rail(s) 108. The controller 204 may selectively control and/or selectively operate the functions, operations, and/or features of the action member(s) 216.

Some embodiments of the aerial device 100 may include one or more sensors 214. The sensors 214 may be mounted on and/or carried by one or more of the body member 110, by the retention member 104, and/or by the collar 106. The sensors 214 may be in communication with one or more of the electronically controlled components of the aerial device 100. The sensors 214 may be utilized to sense and/or detect one or more characteristic data points. For example, but without limitation, the sensors 214 may be utilized to sense and/or detect characteristic data points including, but without limitation, one or more of the relative location of the sensor 214, the body member 110, the retention member 104, the collar 106, and/or of the aerial device 100, the temperature of the local environment and/or the temperature of the payload 102 and/or aerial device 100, the relative location of the aerial device 100 with respect to an object or surface, ground speed of the aerial device 100, wind speed of the aerial device 100, acceleration/deceleration of the aerial device 100, projected trajectory of the aerial device 100, fuel level and/or energy charge of the power unit 208, g-forces on the sensor(s) 214, the aerial device 100, and/or on the payload 102, the humidity level of the local environment, the current status of one or more of the electronically controlled components of the aerial device 100, the location of an object or target 608, and/or the projected path of travel of an object or target.

The sensor(s) 214 may emit a sensor signal related to the characteristic data point(s) detected and/or sensed by the sensor(s) 214, which may be received by the controller 204. The controller 204 may cause one or more predetermined actions to take place based an identification signal received by the controller 204. The controller 204 may also be configured to selectively control and cause one or more of the electronically controlled components of the aerial device 100 to take a predetermined action based one an identification signal received by the controller 204. Examples of the sensor(s) 214 may include, but without limitation, one or more of a temperature sensor, infrared sensor, ultraviolet light sensor, optical sensor, spatial sensor, proximity sensor, laser imaging sensor, radar sensor, ultrasonic sensor, x-ray sensor, visible light sensor, humidity sensor, air pressure sensor, global positioning satellite transceiver, magnetometer, vibration sensor, load sensor, pitot-static sensor, angle of attack sensor, oxygen sensor, ice detector, collision avoidance sensor, terrain sensor, fire sensor, smoke sensor, doppler lidar sensor, anemometer, doppler radar sensor, accelerometer, gyroscope, tachometer, pitot tube, wind speed sensor, and ground speed sensor. More details on the sensors 214, the controller 204, and the identification signals follows further below.

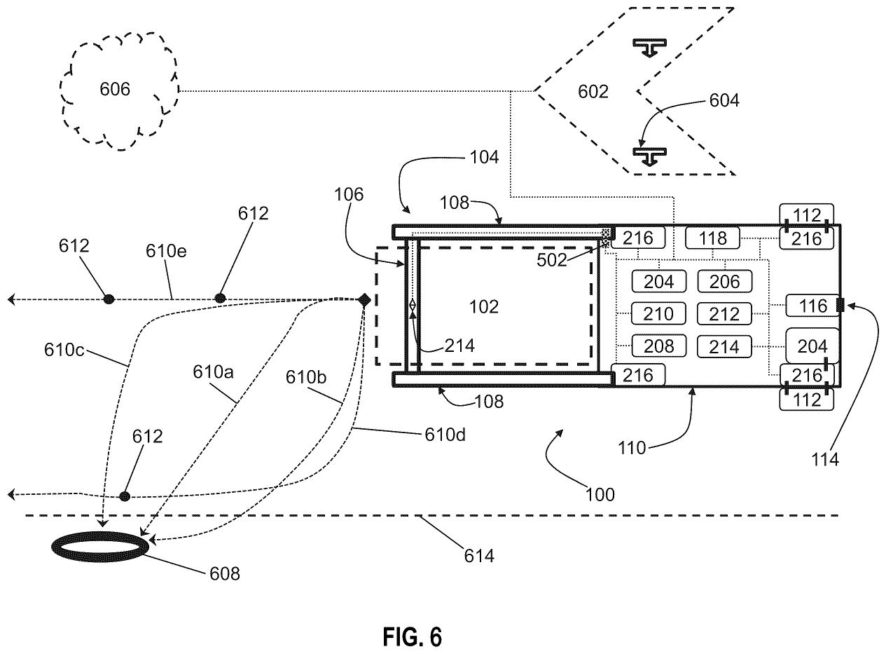

Now specifically referring to FIG. 6, embodiments of the aerial device 100 may be configured to be reversibly attached to an aerial vehicle 602. The aerial vehicle 602 may comprise, but without limitation, an airplane, helicopter, glider, unmanned aerial vehicle, and/or an ultralightweight flying craft. The aerial device 100 may be reversibly attached to the aerial vehicle 602 via one or more of the engagement members 118 of the aerial vehicle 602 being removably engaged with a respective engagement unit 604 of the aerial vehicle 602. One or more of the electronic components of the aerial device 100, such as the controller 204 and/or the communication unit 206, may be positioned in communication with the aerial vehicle 602 when/while one or more of the engagement members 118 are engaged with an engagement unit 604 of the aerial vehicle 602, such that the communication is via the engagement members 118 and their respective engaged engagement units 604. However, it is contemplated that one or more of the communication components and/or electronically controlled components of the aerial device 100 may be in wireless communication with the aerial vehicle 602, which may be communication via a network/communication transceiver 606. More details on the network/communication transceiver 606 follows further below.

In some embodiments of the present invention, the engagement members 118 of the aerial device 100 may be configured to be removably/reversibly attached to, and/or engaged with, preexisting engagement units 604 on current aerial vehicles 602. Those skilled in the art may notice and appreciate that with the engagement members 118 being configured to be removably/reversibly attached to, and/or engaged with, preexisting engagement units 604 on current aerial vehicles 602 that no modification an aerial vehicle 602 may be required to allow the engagement members 118 of the aerial device 100 to be removably/reversibly attached to, and/or engaged with, the engagement units 604 of the aerial vehicle 602. For example, but without limitation, in some embodiments of the present invention the engagement members 118 may be configured to be removably/reversibly attached to, and/or engaged with, engagement units 604 of aerial vehicles 602 that comprise one or more of a hardpoint connection, a pylon connection, an ejector release unit, a rack connector, a munition launcher connector, a fuel tank connector, a munition station connector, a munition pod connector, drop tank connector, and any combinations thereof and/or any other external connector on an aerial vehicle 602 as may be understood by those who may be skilled in the art.

The aerial vehicle 602 may be configured to control, monitor, and/or otherwise manage the aerial device 100 that the aerial vehicle 602 is in communication with to control one or more of the operations of the electronically controlled components of the aerial device 100 and/or monitor the status of one or more of the communication components and/or electronically controlled components of the aerial device 100. For example, but without limitation, the status monitored of the aerial device 100 by the aerial vehicle 602 may include one or more of the weight of the aerial device 100, the characteristics of the payload 102 carried by the aerial device 100, the fuel and/or energy capacity of the power unit 208, and/or the estimated maximum flight range and estimated maximum flight time of the aerial device 100. The aerial device 602 may communicate and control the aerial device 100 to follow a particular path of travel 610a-e for a particular target 608.

The aerial vehicle 602 may also communication a target 608 to the aerial device 100 and one or more of the electronic components of the aerial device 100, such as the controller 204, may determine a path of travel 610a-e for the aerial device 100 to follow upon the aerial device 100 being released from the aerial vehicle 602. The one or more the electronic components of the aerial device 100, such as the controller 204, may also determine a path of travel 610a-e for the aerial device 100 to follow upon the aerial device 100 being released from the aerial vehicle 602 based upon one or more flight factors. The flight factors may include one or more of the current weather conditions, one or more characteristics of the payload 102 carried by the aerial device 100, and/or a path of travel signal received by one or more of the electronic components of the aerial device 100 from the aerial vehicle 602. The characteristics of the payload 102 may include one or more of the weight of the payload 102, the mass of the payload 102, the fragility of the payload 102, the volatility of the payload 102, the maximum acceleration and/or g-force the payload 102 may be subjected to, and/or the type of payload 102.

Embodiments of the aerial device 100 may be configured to carry and deliver a payload 102 to a target 608. The payload 102 carried by the aerial device 100 may include, for example, but without limitation, one or more of food, water, consumables, medical supplies, equipment, shells, clothing, materials, and/or chemical substances, compounds, or mixtures thereof. The electronic components of the aerial device 100, such as the controller 204 based on the sensor signal from the sensor(s) 214, may be configured to determine and identify a path of travel 610a-e for the aerial device 100 to follow from the current position of the aerial device 100 for the aerial device 100 to propel and navigate itself to the target 608 and/or for the aerial device 100 to deliver the payload 102 carried by the aerial device 100 to the target 608. For example, but without limitation, the controller 204 may determine and identify a path of travel 610a-c based on the sensor signal from the sensor(s) 214 for the aerial device 100 to navigate to follow for the aerial device 100 to travel by selectively operating, commanding, and/or controlling the thruster 116, the fins 112, the wings 302, the travel propulsion member 402, and/or the air brake 203 to arrive at the target 608 to deliver the payload 102.

Another example, but without limitation, the controller 204 may determine and identify a path of travel 610d-e based on the sensor signal from the sensor(s) 214 for the aerial device 100 to navigate to follow for the aerial device 100 to travel and perform a predetermined action at an action point 612 along the path of travel 610d-e in order for the aerial device 100 to deliver the payload 102 to/at the target 608. For example, upon the aerial device 100 arriving at one of the action points 612 along a path of travel 610d-e and/or the controller 204 determining that the aerial device 100 is at an action point 612 along a path of travel 610d-e based on the sensor signal from the sensor(s) 214, the controller 204 may cause one or more of the electronic components of the aerial device 100 to take a predetermined action including one or more of: moving the air brake 203 to the deployed position from the stored position; selectively controlling the thruster(s) 116 to change the amount of and/or stop generating a thrust force; changing the orientation of one or more of the fins 112; activating the payload 102, such as commencing a chemical reaction by the payload 102; and, disengaging the retention member 104, collar 106, rail(s) 108, body member 110, body connector 202, and/or action members 216 from one another such as to release the retention member 104 and/or the payload 102 from the aerial device 100 and/or from the body member 110 to allow for the payload 102 to be delivered to the target 608. In some embodiments of the present invention, the payload 102 may include a parachute and/or its own air brake that may deploy upon the payload 102 being released from the aerial device 100 to slow the fall of the payload 102 to the target 608.

One or more of the electronic components of the aerial device 100, such as the controller 204 in cooperation with the sensor(s) 214 via the sensor signal from the sensor(s) 214, may be configured to detect and determine at what point along a path of travel 610a-e that the aerial device 100 has arrived at an action point 612. For example, but without limitation, the controller 204 in cooperation with the sensor(s) 214 and the sensor signal from the sensor(s) 214 may detect and determine that the aerial device 100 has arrived at an action point 612 upon the controller 204 determining that the sensor signal from the sensor(s) 214 indicates an action point trigger. The controller 204 may determine that an action point trigger is indicated by the sensor signal when the sensor signal includes data facts that in summation indicate that the aerial device 100 is at an action point 612 including, but without limitation, current proximity with a target 608, current wind speed, current ground speed, current altitude, current location relative to the ground surface/terrain 614, current distance from the ground surface/terrain 614, and current time of day.

In some embodiments of the present invention, one or more of the electronic communication components of the aerial device 100 may be in communication with a network/communication transceiver 606. For the purposes of the present invention, the network/communication transceiver 606 may be referred to as a communication transceiver 606 without any limitation. The communication transceiver 606 may comprise a communication network and/or a communication device that is in communication with the communication network. The communication network may comprise any network utilized to monitor, manage, facilitate, and/or allow computer-readable communications to be sent thereto, therefrom, and therewith. Examples of the communication network include, but without limitation, a local access network, satellite telecommunications, a wireless communication network, a cell tower communication network, a wide-access network, blue-tooth communications, microwave communications, x-ray communications, and/or at least one network communication server and any combinations thereof, and/or any other network and communication network type as may be understood by those who may have skill in the art.

The communication device may be in communication with one or more of the electronically controlled and/or electronic communication components of the aerial device 100 via the communication network. The communication device may be utilized to monitor the status of, and/or to control the functions of, one or more of the electronically controlled components of the aerial device 100. Examples of the communication device may include, but without limitation, one or more of a computer machine, base station, portable user device, and/or any combinations thereof.

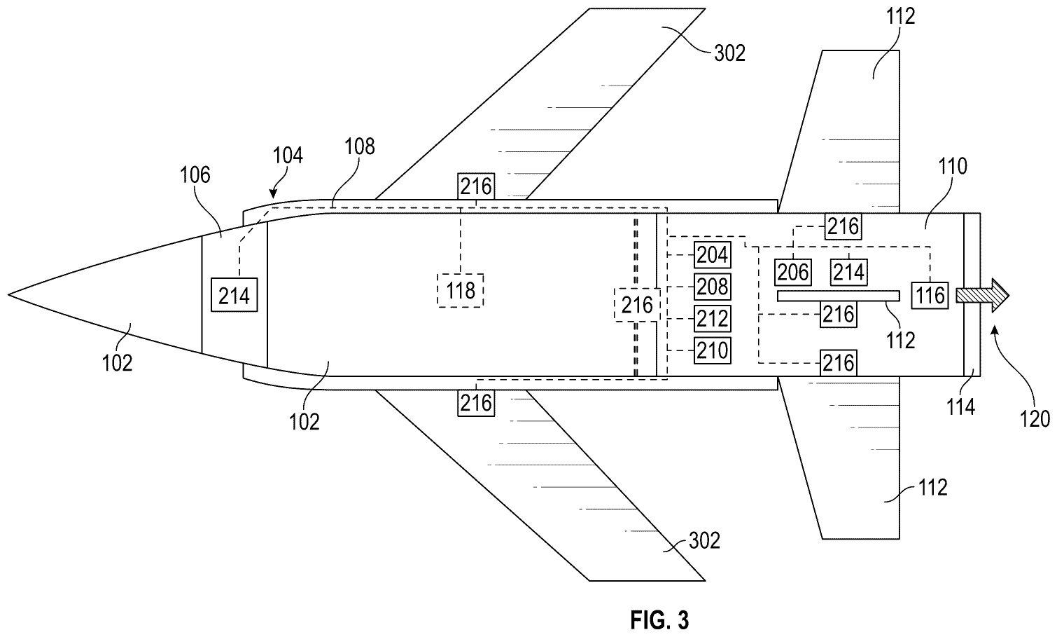

Now referring to FIG. 3, embodiments of the present invention may include one or more wings 302. The wings 302 may be connected to and/or moveably attached to the body member 110, the retention member 104, the rail(s) 108, and/or to the collar 106. The wings 302 may be stationary in relation to the body member 110 of the aerial device 100, and in some embodiments of the present invention, at least a portion of the wings 302 may be rotatably movable about an axis extending through at least a portion of the wing 302, the aerial device 100, the retention member 104 and/or the body member 110body member 110. In some embodiments of the present invention, the wings 302 may include a rotatable portion thereof that may hingedly rotate in relation to its respective wing 302. The wings 302 may be in communication with, and/or selectively controllable by, one or more of the electronic components of the aerial device 100. Each wing 302 may include an action member 216 that may be selectively controlled by the controller 204 to control and cause the wing 302, and/or a rotatable portion of the wing 302 to rotatably move. The rotational movement of the wings 302 and/or of the rotatable portion of the wings 302 may be utilized to control the flight and/or aerial navigation of the aerial device 100 when the aerial device 100 is flying through the air by the trust force generated by the thruster(s) 116.

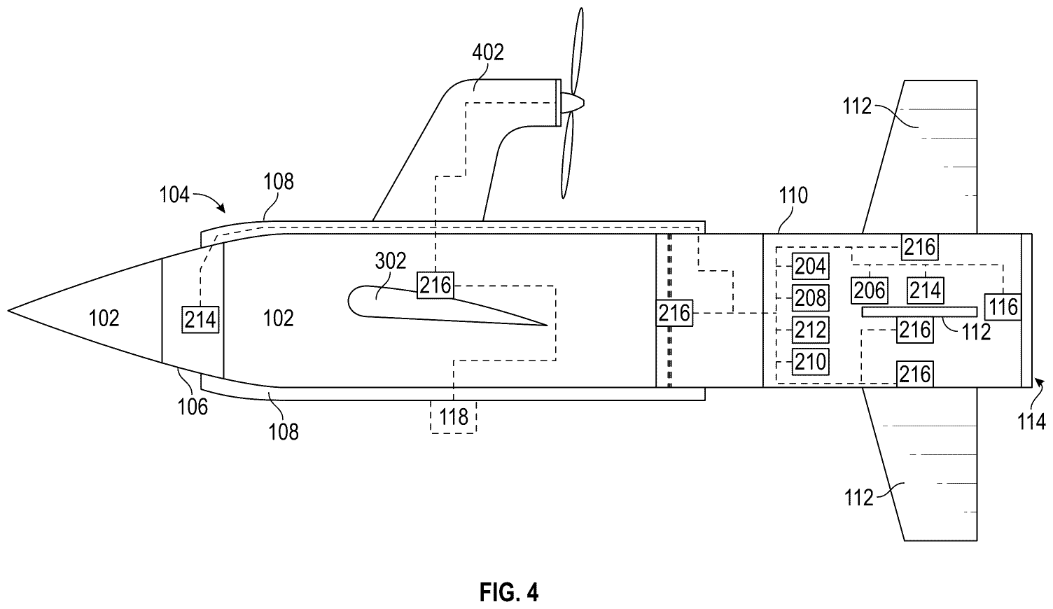

Now referring to FIG. 4, in some embodiments of the present invention, the aerial device may include a travel propulsion member 402. The travel propulsion member 402 may be mounted on and extending from a portion of the body member 110, the retention member 104, and/or the rail(s) 108. The travel propulsion member 402 may be in communication with, and/or selectively controllable by, one or more of the electronic components of the aerial device 100, such as with/by the controller 204 and with the power unit 208. The travel propulsion member 402 may be utilized to selectively generate a travel thrust force in a rearward direction that may be substantially parallel and aligned with a central and/or longitudinal axis of the aerial device 100, the body member 110, and/or the retention member 104body member 110body member 110. Examples of the travel propulsion member 402 include, but without limitation, a jet engine, a combustion engine, a propeller, a rotor, an in-line engine, an electric motor, and any combinations thereof. Those skilled in the art may notice and appreciate that the travel propulsion member 402 may provide a more fuel-efficient source of thrusting forces to allow embodiments of the aerial device 100 to travel for a longer period of time than embodiments of the aerial device 100 that only include thruster(s) 116.

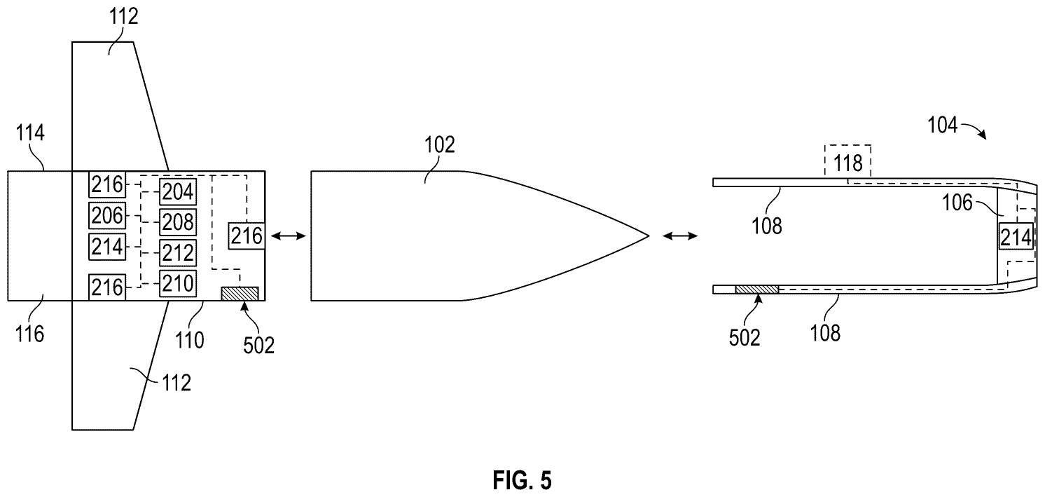

Now referring to FIGS. 5-6, some embodiments of the aerial device 100 may include communication points 502. The communication points 502 may be positioned at a portion of one or more of the retention member 104, the rail(s) 108, the body member 110, and/or the body connector(s) 202. The communication point 502 may be positioned such that at least a pair of the communication point 502 come into communicative contact with one another when the retention member 104 and/or rail(s) 108 are removably/reversibly engaged with, connected to, and/or attached to the body member 110 and/or the body connector 202 of the body member 110 so as to allow communication between one or more of the electronic components of the aerial device 100 that may be separately connected to, and/or carried by, the body member 110 and the retention member 104 and/or rail(s) 108.

Now referring to FIG. 6, for the purposes of the present invention, the target 608 may include a verity of objects, surfaces, locations, and positions. For example, but without limitation, the target 608 may comprise one or more of a location on the ground surface/terrain 614, a structure, a building, a vehicle, a means of transportation, a marked point, a supply drop point, a delivery point, a landing pad, a runway, a drop zone, an area of the ground surface/terrain 614, and/or any combinations thereof and/or any other object, surface, location, or position as may be understood by those who may have skill in the art. The sensor(s) 214 may be configured to sense one or more characteristic data point(s) pertaining to a target 608 and relay the sensed characteristic data point(s) to one or more of the electronic components of the aerial device 100, such as to the controller 204, as data sensor signal. For example, but without limitation, the sensor(s) 214 may be configured to sense information pertaining to a target 608 including one or more of, a target type, a target location, a target projected movement path, a target composition, relative distance to the target in relation to the aerial device 100, target temperature, and/or any combinations thereof.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An aerial device comprising:
a body member; and
a retention member having an interior space and a rearward portion that is operable to matingly engage with a forward portion of the body member to carry a payload within the interior space in cooperation with the forward portion of the body member;
wherein the retention member includes a collar having an inner perimeter that defines an opening that is in communication with the interior space;
wherein a forward portion of the payload extends through the opening while the rearward portion of the retention member is matingly engaged with the forward portion of the body member; and
wherein the inner perimeter of the collar substantially abuts a portion of an outer surface of the payload while the rearward portion of the retention member is matingly engaged with the forward portion of the body member.

2. The aerial device according to claim 1, wherein the retention member includes at least one rail having an end portion connected to the collar.

3. The aerial device according to claim 2, wherein at least a portion of an inward surface of the at least one rail significantly abuts a portion of the outer surface of the payload while the rearward portion of the retention member is matingly engaged with the forward portion of the body member.

4. The aerial device according to claim 1, further comprising at least one engagement member mounted on at least one of the body member and the retention member; wherein the at least one engagement member is operable to be reversibly engaged with an engagement unit of an aerial vehicle.

5. The aerial device according to claim 1, further comprising a thruster to selectively provide a thrust force; and a plurality of fins connected to and extending from the body member; wherein at least a portion of each one of the plurality of fins is operable to rotatably move.

6. The aerial device according to claim 5, further comprising wings connected to at least one of the body member and the retention member; wherein at least a portion of each of the wings is operable to rotatably move.

7. The aerial device according to claim 6, further comprising a travel propulsion member mounted on and extending from at least one of a portion of the body member and a portion of the retention member; wherein the travel propulsion member is operable to generate a travel thrust in a rearward direction.

8. The aerial device according to claim 5, further comprising:
a controller in communication with the thruster and the plurality of fins;
at least one sensor positionable in communication with the controller and operable to sense at least one characteristic data point; and
a power unit in communication with the controller and the at least one sensor;
wherein the at least one sensor is operable to provide a sensor signal based on the at least one characteristics data point; and
wherein the controller is operable to selectively control at least one of the thruster and the fins based on the sensor signal.

9. The aerial device according to claim 8, further comprising:
at least one body communication point carried by the body member; and
at least one retention communication point carried by the retention member;
wherein the controller and the power unit are carried by the body member and in communication with the at least one body communication point;
wherein the at least one sensor is carried by the retention member and in communication with the at least one retention communication point; and
wherein the at least one body communication point engages in communication with the at least one retention communication point when and while the rearward portion of the retention member is matingly engaged with the forward portion of the body member.

10. The aerial device according to claim 8, wherein the controller is operable to determine at least one path of travel based on the sensor signal; and wherein the controller is operable to selectively control at least one of the thruster and the fins based on the at least one path of travel determined.

11. An aerial device comprising:
a body member;
a retention member having an interior space and a rearward portion that is operable to matingly engage with a forward portion of the body member to carry a payload within the interior space in cooperation with the forward portion of the body member;
at least one engagement member mounted on at least one of the body member and the retention member;
a thruster to selectively provide a thrust force; and
a plurality of fins connected to and extending from the body member;
wherein the retention member includes a collar having an inner perimeter that defines an opening that is in communication with the interior space;
wherein a forward portion of the payload extends through the opening while the rearward portion of the retention member is matingly engaged with the forward portion of the body member;
wherein the inner perimeter of the collar substantially abuts a portion of an outer surface of the payload while the rearward portion of the retention member is matingly engaged with the forward portion of the body member;
wherein the retention member includes at least one rail having an end portion connected to the collar;
wherein at least a portion of an inward surface of the at least one rail significantly abuts a portion of the outer surface of the payload while the rearward portion of the retention member is matingly engaged with the forward portion of the body member; and
wherein the at least one engagement member is operable to be reversibly engaged with an engagement unit of an aerial vehicle.

12. The aerial device according to claim 11, further comprising wings connected to at least one of the body member and the retention member; wherein at least a portion of each of the wings is operable to rotatably move.

13. The aerial device according to claim 12, further comprising a travel propulsion member mounted on and extending from at least one of a portion of the body member and a portion of the retention member; wherein the travel propulsion member is operable to generate a travel thrust in a rearward direction.

14. The aerial device according to claim 11, further comprising:
a controller in communication with the thruster and the plurality of fins;
at least one sensor positionable in communication with the controller and operable to sense at least one characteristic data point; and
a power unit in communication with the controller and the at least one sensor;
wherein the at least one sensor is operable to provide a sensor signal based on the at least one characteristics data point;
wherein at least a portion of each one of the plurality of fins is operable to rotatably move;
wherein the controller is operable to selectively control at least one of the thruster and the fins based on the sensor signal.

15. The aerial device according to claim 14, further comprising:
at least one body communication point carried by the body member; and
at least one retention communication point carried by the retention member;
wherein the controller and the power unit are carried by the body member and in communication with the at least one body communication point;
wherein the at least one sensor is carried by the retention member and in communication with the at least one retention communication point; and
wherein the at least one body communication point engages in communication with the at least one retention communication point when and while the rearward portion of the retention member is matingly engaged with the forward portion of the body member.

16. The aerial device according to claim 14, wherein the controller is operable to determine at least one path of travel based on the sensor signal; and wherein the controller is operable to selectively control at least one of the thruster and the fins based on the at least one path of travel determined.

17. An aerial device comprising:
a body member;
a retention member comprising a collar and at least one rail that has a forward end portion connected to the collar;
at least one engagement member mounted on at least one of the body member and the at least one rail;
a thruster to selectively provide a thrust force;
a plurality of fins connected to and extending from the body member;
a controller in communication with the thruster and the plurality of fins;
at least one sensor operable to sense at least one characteristic data point;
a power unit in communication with the controller and positionable in communication with the at least one sensor;
at least one body communication point carried by the body member; and
at least one retention communication point carried by the at least one rail;
wherein the collar and the at least one rail define an interior space;
wherein the collar has an inner perimeter that defines an opening that is in communication with the interior space;
wherein the at least one rail includes a rearward end portion that is operable to matingly engage with a forward portion of the body member to carry a payload within the interior space in cooperation with the forward portion of the body member;
wherein a forward portion of the payload extends through the opening while the rearward portion of the at least one rail is matingly engaged with the forward portion of the body member;
wherein both the inner perimeter of the collar and at least a portion of an inward surface of the at least one rail substantially abuts a portion of an outer surface of the payload while the rearward portion of the at least one rail is matingly engaged with the forward portion of the body member;
wherein the at least one engagement member is operable to be reversibly engaged with an engagement unit of an aerial vehicle;
wherein the at least one sensor is operable to provide a sensor signal based on the at least one characteristics data point;
wherein at least a portion of each one of the plurality of fins is operable to rotatably move;
wherein the controller is operable to selectively control at least one of the thruster and the fins based on the sensor signal;
wherein the controller and the power unit are carried by the body member and in communication with the at least one body communication point;
wherein the at least one sensor is carried by the retention member and in communication with the at least one retention communication point; and
wherein the at least one body communication point engages in communication with the at least one retention communication point when and while the rearward portion of the at least one rail is matingly engaged with the forward portion of the body member.

18. The aerial device according to claim 17, further comprising wings connected to at least one of the body member and the at least one rail; wherein at least a portion of each of the wings is operable to rotatably move.

19. The aerial device according to claim 18, further comprising a travel propulsion member mounted on and extending from at least one of a portion of the body member and a portion of the at least one rail; wherein the travel propulsion member is operable to generate a travel thrust in a rearward direction.

20. The aerial device according to claim 17, wherein the controller is operable to determine at least one path of travel based on the sensor signal; and wherein the controller is operable to selectively control at least one of the thruster and the fins based on the at least one path of travel determined.
